(19) United States
(12) Patent Application Publication
(10) Pub. No.: US 2021/0309431 A1
(43) Pub. Date: Oct. 7, 2021

(54) Break-Open Single-Dose Packages

(71) Applicant: Contract Pharmaceuticals Limited, Mississauga (CA)

(72) Inventors: Matthew J. TRAMONTANA, Pennington, NJ (US); Stephen E. SIMANTIRAS, Randolph, NJ (US); Michael QUINN, East Hanover, NJ (US); Tor ALDEN, Basking Ridge, NJ (US)

(21) Appl. No.: 17/263,411

(22) PCT Filed: Apr. 15, 2020
(86) PCT No.: PCT/IB2020/000281

§ 371 Date: Jan. 26, 2021

Related U.S. Application Data
(60) Provisional application No. 62/964,958, filed on Jan. 23, 2020.
(60) Provisional application No. 62/925,510, filed on Oct. 24, 2019.
(60) Provisional application No. 62/834,111, filed on Apr. 15, 2019.

(51) Int. Cl. B65D 75/32; B65D 75/58; B65D 83/00; A61J 1/14; A45D 34/00

(52) U.S. Cl. CPC B65D 75/325; B65D 75/58; B65D 83/0055; A45D 2200/05; A45D 34/00; A45D 2200/10; A61J 1/1443

(57) ABSTRACT

A break-open single-dose package includes a panel defining one or more frangible regions, one or more sheets coupled to the panel and defining one or more pockets therebetween for storing one or more spreadable consumables, and an applicator. The frangible region(s) are adapted to form one or more openings through which the spreadable consumable(s) can exit in response to folding of the panel. The applicator may include one or more optional features such as a chamber, a backing, a tab, a blade, a grip, etc. to permit a user to spread on a surface any spreadable consumable(s) that exit the pocket(s) using the applicator without requiring the user's hand(s) to contact the spreadable consumable(s).

### CROSS-REFERENCE TO RELATED APPLICATIONS

This application claims the benefit and priority of U.S. Provisional Application No. 62/834,111, filed Apr. 15, 2019, U.S. Provisional Application No. 62/925,510, filed Oct. 24, 2019, and U.S. Provisional Application No. 62/964,958, filed Jan. 23, 2020. The entire disclosure of each of the above applications is incorporated herein by reference.

### FIELD

The present disclosure relates to break-open single-dose packages.

### BACKGROUND

This section provides background information related to the present disclosure which is not necessarily prior art.

Various types of storage vessels exist for storing dispensable substances such as medicated creams, gels, lotions, etc. In some cases, a storage vessel may include a rigid or semi-rigid panel and a flexible sheet sealed to the panel to define a pocket between the panel and the flexible sheet for storing the dispensable substance. The panel includes one or more scored lines on one or both sides of the panel. When the storage vessel is folded or otherwise manipulated by a user, the scored line(s) may break allowing the dispensable substance to exit the pocket and pass through the panel. The user may then dispense the stored substance onto a person's skin.

### SUMMARY

This section provides a general summary of the disclosure, and is not a comprehensive disclosure of its full scope or all of its features.

According to one aspect of the present disclosure, a break-open single-dose package includes a panel defining one or more frangible regions, one or more sheets coupled to the panel and defining at least two pockets therebetween for storing spreadable consumables, and an applicator. The one or more frangible regions are adapted to form an opening through which the spreadable consumables can exit in response to folding of the panel. The applicator includes a chamber having a perimeter wall and a divider wall. The perimeter wall and the divider wall define at least two channels in fluid communication with the one or more frangible regions for receiving the spreadable consumables from the at least two pockets in response to folding of the panel. The divider wall separates the at least two channels to prevent the spreadable consumables from the at least two pockets from mixing when passing through the at least two channels. The applicator is positioned adjacent the one or more frangible regions for permitting a user to spread on a surface any spreadable consumables that exit the at least two pockets using the applicator without requiring the user's hand(s) to contact the spreadable consumables.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an isometric view of a break-open single-dose package having an applicator with backings defining cutouts and a chamber positioned between the backings according to one example embodiment of the present disclosure.

FIG. 2 is a cross-sectional view of the package of FIG. 1.

FIG. 3 is a bottom side view of the package of FIG. 1.

FIG. 4 is an isometric view of the package of FIG. 1 with the package in its folded position.

FIG. 5 is a sectional isometric view of a portion of the applicator of FIG. 1.

FIG. 6 is a bottom view an applicator including backings and a chamber between the backings according to another example embodiment.

FIG. 7 is an isometric view of a break-open single-dose package having an applicator with an auger according to yet another example embodiment.

FIG. 8 is an isometric view of the package of FIG. 7 with the package in its folded position.

FIG. 9 is an exploded isometric view of the package of FIG. 7.

FIG. 10 is an isometric view of a break-open single-dose package having an applicator with an absorber according to another example embodiment.

FIG. 11 is an isometric view of the package of FIG. 10 with the package in its folded position.

FIG. 12 is an exploded isometric view of the package of FIG. 10.

FIG. 13 is an isometric view of a break-open single-dose package having an applicator with an elongated tab according to yet another example embodiment.

FIG. 14 is a bottom side view of the package of FIG. 13.

FIG. 15 is an isometric view of the package of FIG. 13 with the package in its folded position.

FIG. 16 is an exploded isometric view of the package of FIG. 13.

FIG. 17 is an isometric view of a break-open single-dose package having an applicator with a blade according to another example embodiment.

FIG. 18 is an isometric view of the package of FIG. 17 with the package in its folded position.

FIG. 19 is an exploded isometric view of the package of FIG. 17.

FIG. 20 is an isometric view of a break-open single-dose package having an applicator with no grips according to yet another example embodiment.

FIG. 21 is an exploded isometric view of a break-open single-dose package having a panel and an applicator coupled to the panel via adhesive tape, according to according to another example embodiment.

Corresponding reference numerals indicate corresponding (but not necessarily identical) parts and/or features throughout the several views of the drawings.

### DETAILED DESCRIPTION

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Example embodiments will now be described more fully with reference to the accompanying drawings.

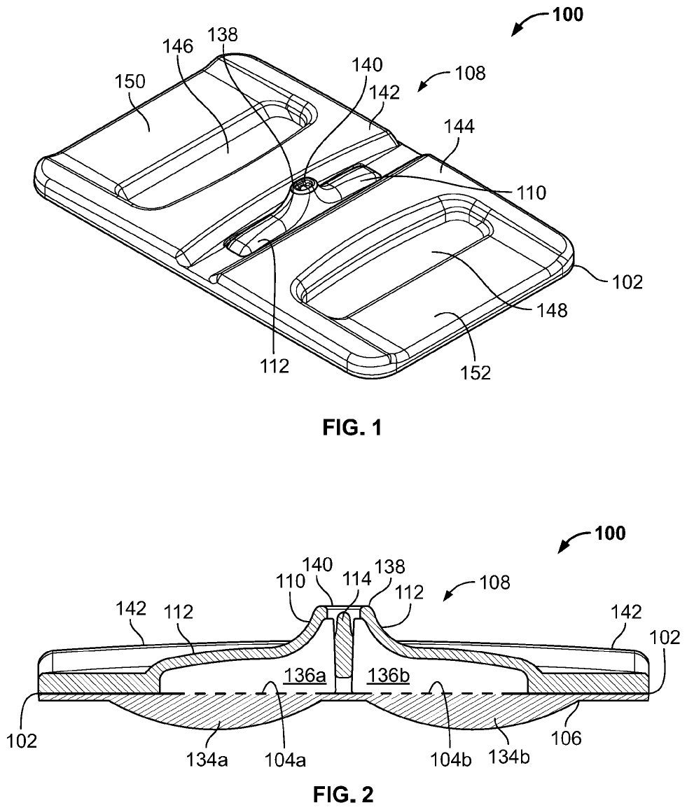

A break-open single-dose package according to one example embodiment of the present disclosure is illustrated in FIGS. 1-5, and indicated generally by reference number 100. As shown in FIGS. 1-5, the break-open single-dose package 100 includes a panel 102 defining two frangible regions 104a, 104b, a sheet 106 coupled to the panel 102 and defining two pockets 134a, 134b therebetween for storing spreadable consumables 132a, 132b, and an applicator 108 positioned adjacent to the frangible regions 104a, 104b. The frangible regions 104a, 104b each form an opening through which the spreadable consumables 132a, 132b can exit in response to folding of the panel 102. As shown, the applicator 108 includes a chamber 110 having a perimeter wall 112 and a divider wall 114. The perimeter wall 112 and the divider wall 114 defining two channels 136a, 136b in fluid communication with the frangible regions 104a, 104b for receiving the spreadable consumables 132a, 132b from the pockets 134a, 134b in response to folding of the panel 102. The applicator 108 permits a user to spread on a surface any spreadable consumables 132a, 132b that exit the pockets 134a, 134b using the applicator 108 without requiring the user's hand(s) to contact the spreadable consumables 132a, 132b.

In the example of FIGS. 1-5, the divider wall 114 separates the channels 136a, 136b. In such examples, the divider wall 114 prevents the spreadable consumables 132a, 132b from mixing when passing through the channels (e.g., reservoirs) 136a, 136b. The spreadable consumables 132a, 132b may mix, remain substantially separated, etc. after flowing past the divider wall 114. For example, the spreadable consumables 132a, 132b may mix after the consumables exit the applicator 108, within the applicator between the divider wall 114 and the applicator's outlet, etc. In some examples, mixing of the spreadable consumables 132a, 132b may occur due to, for example, a user shaking the package 100 to cause turbulence in the chamber 110.

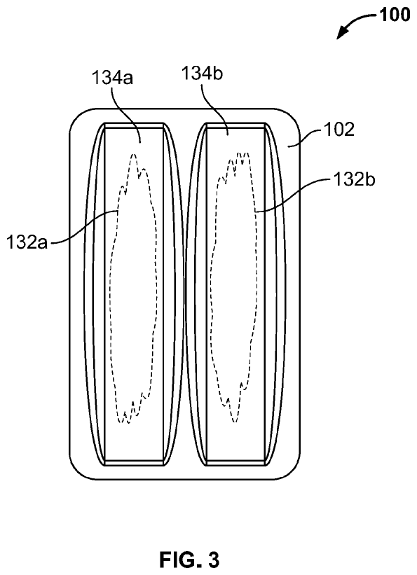

In some examples, the applicator 108 may entirely cover the frangible regions 104a, 104b. For example, and as shown in FIG. 2, the perimeter wall 112 covers and surrounds the frangible regions 104a, 104b. For instance, the perimeter wall 112 may be positioned to ensure the channels 136a, 136b surround the frangible regions 104a, 104b. In such examples, any of the spreadable consumable 132a exiting the pocket 134a flows through the opening in the frangible region 104a and into the channel 136a, and any of the spreadable consumable 132b exiting the pocket 134b flows through the opening in the frangible region 104b and into the channel 136b. In other examples, the frangible regions 104a, 104b may extend beyond the perimeter wall 112 and/or the channels 136a, 136b if desired.

In some examples, the channels 136a, 136b may have the same volume. For example, the perimeter wall 112 may be substantially symmetrical on opposing sides of the divider wall 114. This may help ensure the spreadable consumables 132a, 132b are mixed in a 1:1 ratio as further explained below. In other examples, the channels 136a, 136b may have the different volumes.

The perimeter wall 112 defines at least a portion of the channels 136a, 136b. For example, and as shown in FIG. 2, the perimeter wall 112 represents at least some of the outer portion of the chamber 110 and extends away from the panel 102. Specifically, the perimeter wall 112 extends away from the panel 102 and converges toward a fluid outlet of the chamber 110. In some examples, the perimeter wall 112 may form a funnel shape from the panel 102 to the fluid outlet of the chamber 110. In such examples, the panel 102 may define a lower boundary of the channels 136a, 136b, and the perimeter wall 112 extending away from the panel 102 may define an upper boundary of the channels 136a, 136b.

In some examples, the chamber 110 may include a tip portion 138 positioned remote from the panel 102. As shown in FIGS. 1, 2, 4 and 5, the tip portion 138 defines an opening 140 in fluid communication with the channels 136a, 136b for permitting the spreadable consumables 132a, 132b from the pockets 134a, 134b to exit the applicator 108. In some examples, the tip portion 138 may be a portion of the perimeter wall 112.

The chamber 110 may be sized to ensure the distance between the panel 102 and the tip portion 138 is appropriate. For example, the perimeter wall 112 may extend away from the panel 102 a defined distance and/or the tip portion 138 may be sized to ensure the tip portion 138 is an appropriate distance away from the panel 102. This may assist users in viewing the spreadable consumables 132a, 132b exiting the applicator 108. In some examples, the perimeter wall 112 and/or the tip portion 138 may be sized to ensure the end of the tip portion 138 (e.g., the outermost edge of the chamber 110) is about 4.5 mm, 5 mm, 6 mm, etc. away from the panel 102.

As shown in FIG. 2, the divider wall 114 is a wall located within the chamber 110 for separating the channels 136a, 136b. Specifically, the divider wall 114 extends between the panel 102 and the opening 140 in the chamber 110. In some examples, the divider wall 114 may extend from the panel 102 to an area slightly below the outer edge of the chamber's opening 140 as shown in FIG. 2. In such examples, the area slightly below the outer edge of the chamber's opening 140 may be considered a mixing area, and the divider wall 114 is positioned to ensure the spreadable consumables 132a, 132b remain isolated from each other until they reach this area. Thus, in this example, the spreadable consumables 132a, 132b mix (at least partially) within the chamber 110, but near the chamber's outlet (e.g., the opening 140). In other examples, the divider wall 114 may extend from the panel 102 to or beyond the outer edge of the chamber's opening 140.

As explained above, the applicator 108 is positioned adjacent to the frangible regions 104a, 104b in the panel 102. For example, and as shown in FIG. 2, the channels 136a, 136b defined by the chamber 110 are adjacent to and in fluid communication with the frangible regions 104a, 104b. When the panel 102 is folded, each pocket 134a, 134b is folded (e.g., compressed) onto itself and its corresponding frangible region 104a, 104b is broken (as further explained below). As such, the spreadable consumables 132a, 132b flow from their corresponding pockets 134a, 134b through the openings in the frangible regions 104a, 104b, and into the channels 136a, 136b. The spreadable consumables 132a, 132b flow beyond the divider wall 114 and mix (at least partially). In some examples, the spreadable consumables 132a, 132b may have substantially the same flow rate due to the uniform pressure applied to the pockets 134a, 134b (as explained herein). In other examples, the spreadable consumables may have different flow rates if desired. The mixed spreadable consumables 132a, 132b may then exit the chamber 110 via the opening 140 and be applied to, spread across, etc. a surface. In some examples, the spreadable consumables 132a, 132b may be stored in the channels 136a, 136b prior to applying, spreading, etc. the spreadable consumables 132a, 132b.

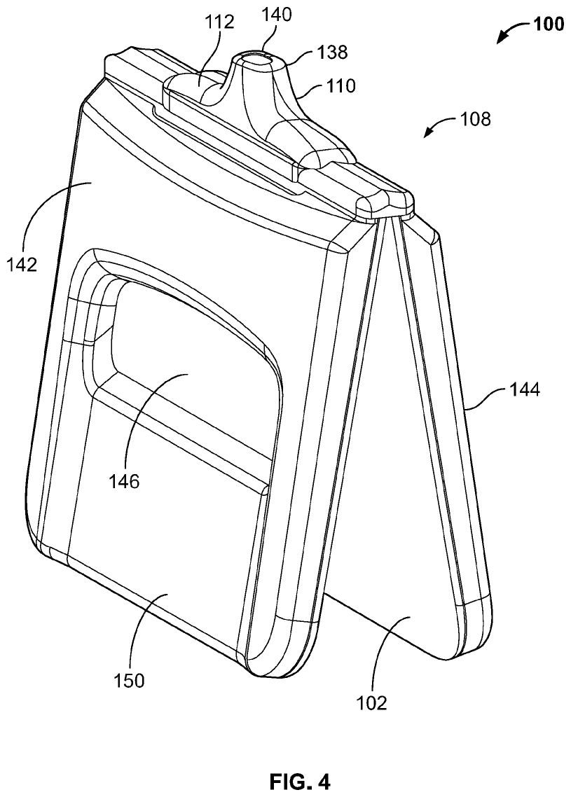

In some examples, the applicator 108 may optionally include one or more supports for providing at least some rigidity. For example, and as shown in FIGS. 1, 2, 4 and 5, the applicator 108 includes two rigid backings 142, 144 positioned on opposing sides of the chamber 110 for applying a substantially uniform pressure to the pockets 134a, 134b in response to folding of the panel 102. In some examples, the backings 142, 144 may be substantially mirrored on opposing sides of the chamber 110. This may ensure the distribution of pressure is uniformly applied across the pockets 134a, 134b when the panel 102 is bent, folded, etc. as shown in FIG. 4. For example, the panel 102 may fold about an axis as shown in FIG. 4. When the panel 102 is folded, the rigid backings 142, 144 may be symmetrically positioned on opposing sides of the package 100 (e.g., on opposing sides of the folding axis) to ensure uniform pressure is applied to the pockets 134a, 134b.

As shown, the backings 142, 144 define cutouts 146, 148. As shown, the cutouts 146, 148 are substantially oval shaped. For example, and as shown in FIGS. 1, 4 and 5, each cutout 146, 148 includes an arced inner side (e.g., adjacent to the chamber 110), a substantially linear outer side (e.g., distal to the chamber 110), and opposing rounded sides between the arced inner side and the linear outer side. In other examples, one or both cutouts 146, 148 may have an arc shape (e.g., as further explained below), a circular shape, a rectangular shape, a triangular shape, and/or another suitable shape. In some examples, the cutouts 146, 148 may be thumb and/or finger wells, reduce material and costs compared to other applicator designs, etc.

In some examples, the backings 142, 144 may have varying thicknesses. For example, each backing 142, 144 includes an inner portion adjacent to the chamber 110 and an outer portion distal to the chamber 110. In such examples, the inner portions of the backing 142, 144 may have a greater thickness than the outer portions.

Additionally and/or alternatively, the outer portions of the backings 142, 144 may have varying thicknesses. For example, and as shown in FIGS. 1, 4 and 5, the backings 142, 144 include ramps 150, 152 between outer edges (e.g., a perimeter) of the backings 142, 144 and the cutouts 146, 148. The ramps 150, 152 may define the linear outer sides of the cutouts 146, 148 as shown in FIGS. 1, 4 and 5. In some examples, the side of each ramp 150, 152 adjacent to its corresponding cutout 146, 148 may have a greater thickness than the opposing side of the ramp 150, 152 adjacent to the applicator's perimeter. In other examples, the backings 142, 144 and/or the ramps 150, 152 may be the same thicknesses if desired.

The ramps 150, 152 and/or the cutouts 146, 148 of the backings 142, 144 may function as grips (e.g., touchpoints) for facilitating user control of the package 100. For example, the ramps 150, 152 and/or the cutouts 146, 148 may indicate to users ideal locations for most effectively and efficiently handling the package 100, assist users in grasping, handling, etc. the package 100, etc.

In some examples, the applicator 108 may be substantially coextensive with the panel 102. For example, and as shown in FIGS. 1 and 4, the applicator 108 may have substantially the same size, shape, etc. as the panel 102. For instance, the applicator 108 may substantially cover one side of the panel 102. In such examples, the width of the chamber 110 may be substantially equal to the width of the panel 102 (e.g., the distance between outer edges of the panel 102 and parallel to the folding axis). In other examples, the backings 142, 144 and/or the chamber 110 may not extend to one or more edges of the panel 102, and/or may extend beyond one or more edges of the panel 102.

As shown in FIG. 4, the backings 142, 144 move with the panel 102 in response to folding of the panel 102. This allows the backings 142, 144 to separate from the chamber 110. As such, the chamber 110 (and more specifically, the tip portion 138) becomes at least somewhat isolated from the rest of the package 100. As a result, the user may grasp the panel 102 and use the chamber 110 (e.g., the tip portion 138) to apply and spread on a surface the spreadable consumables 132a, 132b that exit the pockets 134a, 134b without requiring the user's hand(s) to contact the spreadable consumables 132a, 132b.

In some examples, the chamber 110 may remain substantially stationary and maintain its shape when the panel 102 is folded and the backings 142, 144 are moved as shown in FIG. 4. For example, the chamber 110 may maintain its funnel-like shape when the panel 102 is moved. In such examples, edges of the chamber 110 may cover corners of the panel 102 created when the panel 102 is folded. In other examples, the chamber 110 may move causing the chamber 110 to slightly deform when the backings 142, 144 are moved and separated from the chamber 110, as further explained below.

In some embodiments, the backings 142, 144 and the chamber 110 of the applicator 108 may be formed of the same material or different materials, one continuous piece of material (e.g., a monolithic construction), separate components coupled together, etc. In some examples, the material used to form the backings 142, 144 may be more rigid (e.g., less flexible) than the material used to form the chamber 110. For example, the backings 142, 144 may be formed of a first material such as a rigid thermoplastic material (e.g., acrylonitrile butadiene styrene (ABS) and/or another suitable material), and the chamber 110 may be formed of a second material such as a flexible thermoplastic material (e.g., thermoplastic elastomer (TPE) and/or another suitable material).

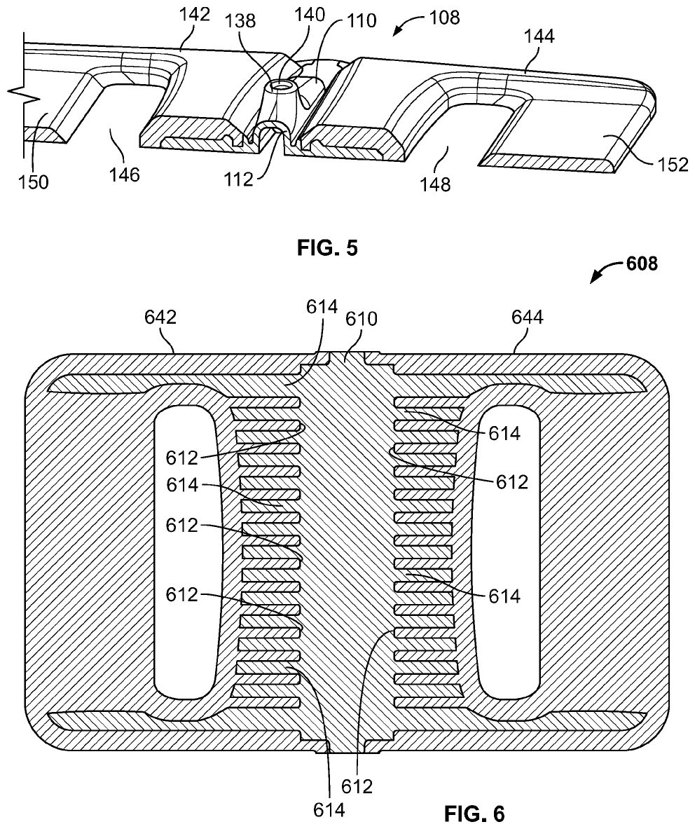

During production of the applicator 108, the backings 142, 144 and the chamber 110 may be formed by one or more molding processes such as injection molding, overmolding, etc. For example, the backings 142, 144 may be formed by injection molding. After the backings 142, 144 are formed, the chamber 110 may be formed by overmolding a material into and between the backings 142, 144. For example, each backing 142, 144 may include one or more hollow portions on a side adjacent to the panel 102, as further explained below. In such examples, a material forming the chamber 110 may flow under portions of the backings 142, 144 filling the hollow portions of the backings 142, 144, as shown in FIG. 5. Once solidified, the chamber 110 and the backings 142, 144 may be connected together.

In some examples, one or both backings 142, 144 may include one or more rib structures positioned adjacent to the chamber 110. For example, FIG. 6 illustrates an applicator 608 for use in a break-open single-dose package such as the package 100 of FIGS. 1-5. The applicator 608 of FIG. 6 includes backings 642, 644 and a chamber 610 substantially similar to the backings 142, 144 and the chamber 110 of FIGS. 1-5. However, in FIG. 6, the backings 642, 644 include multiple rib structures 612 positioned adjacent to the chamber 610. Specifically, and as shown in FIG. 6, the rib structures 612 extend from an area adjacent to cutouts (e.g., similar to the cutouts 146, 148 of FIGS. 1-5) in the backings 642, 644 to an area adjacent to the chamber 610. The rib structures 612 may help support the backings 642, 644 (e.g., provide structural integrity), provide uniform pressure across pockets storing spreadable consumables to ensure uniform flow as explained herein, etc.

In the particular example of FIG. 6, the backings 642, 644 may be at least partially hollow to reduce material and costs compared to other applicator designs. For example, the backings 642, 644 may define hollow portions along their undercarriage (e.g., sides adjacent to a panel). Some of the hollow portions may be positioned around the rib structures 612 of the backings 642, 644, while other hollow portions may extend adjacent to edges of the backings 642, 644 and beyond the cutouts. In such examples, the chamber 610 may include fingers 614 filling some or all of the hollow portions.

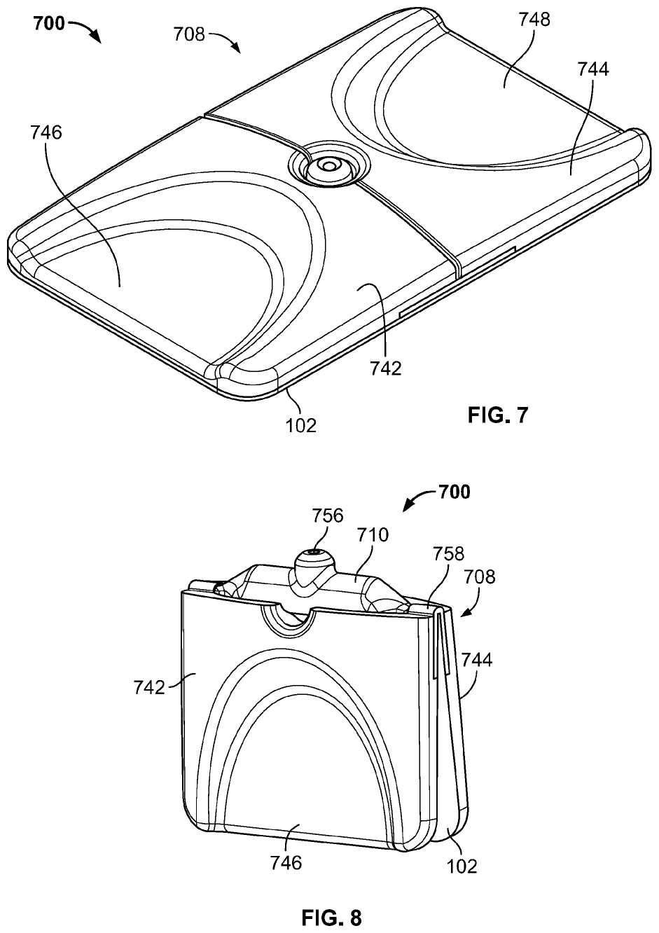

In some examples, the applicators disclosed herein may include one or more structures for mixing any spreadable consumables that exits their corresponding pockets. In such examples, the structure(s) may cause turbulence in the chamber, and as a result, mix the spreadable consumables. For example, FIG. 7-9 illustrate a break-open single-dose package 700 including the panel 102 defining the frangible regions 104a, 104b, and the pockets 134a, 134b for storing spreadable consumables 132a, 132b of FIGS. 1-5, and an applicator 708 positioned adjacent the frangible regions 104a, 104b (as explained above).

The applicator 708 is similar to the applicator 108 of FIGS. 1-5, but includes an auger 754 for mixing together portions of the spreadable consumables 132a, 132b that have exited the pockets 134a, 134b. Specifically, the applicator 708 includes a chamber 710 defining a reservoir (e.g., a channel) in fluid communication with the frangible regions 104a, 104b for receiving the spreadable consumables 132a, 132b from the pockets 134a, 134b in response to folding of the panel 102, an optional backing 758 for supporting the chamber 710, and the auger 754 positioned in the chamber 710 for mixing together the spreadable consumables 132a, 132b from the pockets 134a, 134b.

For example, the chamber 710 may include an opening adjacent the frangible region 104a for receiving any spreadable consumable departing the pocket 134a, and another opening adjacent the frangible region 104b for receiving any spreadable consumable departing the pocket 134b. In other examples, the chamber 710 may include a single opening extending adjacent both frangible regions 104a, 104b. In such examples, the single opening may extend along the entire bottom side of the chamber 710, or an area less than the entire bottom side of the chamber 710.

As shown in FIGS. 7-9, the applicator 708 includes an opening 756 for permitting a user to apply any spreadable consumables 132a, 132b that exit the chamber's reservoir on a surface without requiring the user's hand(s) to contact the spreadable consumable. In such examples, the reservoir may be in fluid communication with the applicator's opening 756. Any spreadable consumables 132a, 132b that exit the pockets 134a, 134b may collect in the reservoir, and then pass through the opening 756 of the applicator 708 to allow the user to spread the spreadable consumables 132a, 132b from both pockets 134a, 134b.

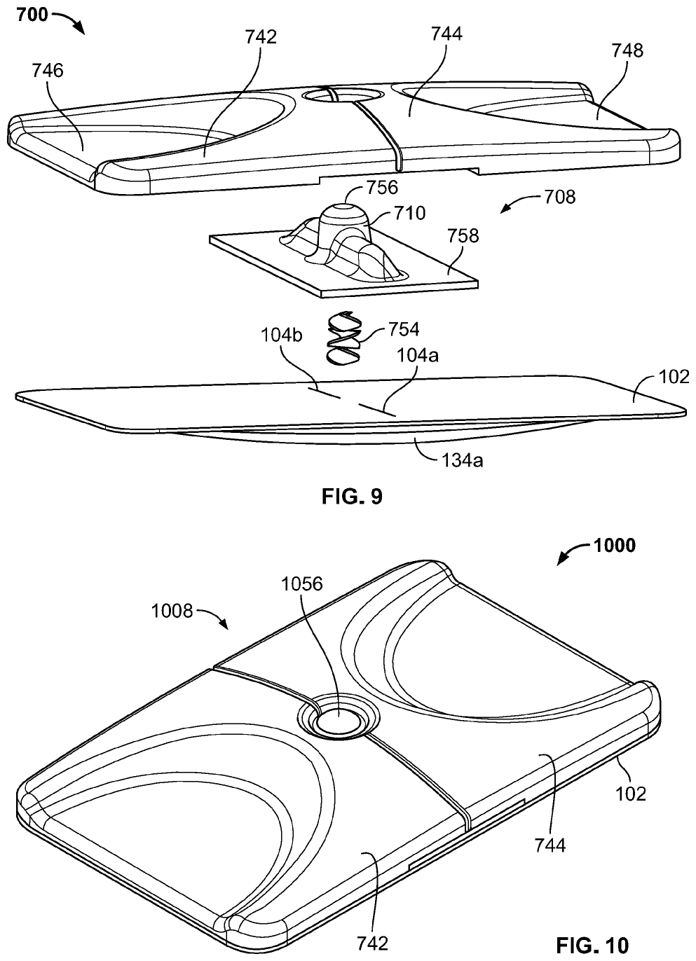

As shown in FIG. 9, the auger 754 may have a helical shape. For example, the auger 754 may have an outer spiraling protuberance that causes the spreadable consumables 132a, 132b from the pockets 134a, 134b to mix as the spreadable consumables pass by the auger 754 (e.g., a turbulent path). In other examples, the auger 754 may have another suitable shape such as one or more non-aligned segmented protuberances, etc.

The applicator 708 may include rigid backings 742, 744 that are substantially similar to the rigid backings 142, 144 of FIGS. 1-5. For example, the backings 742, 744 may be substantially mirrored and positioned on opposing sides of the chamber 710 for applying a substantially uniform pressure to the pockets 134a, 134b when the panel 102 is folded. Additionally, the backings 742, 744 may move with the panel 102 and separate from the chamber 710 when the panel 102 is folded, etc. as explained above relative to FIGS. 1-5. For example, and as shown in FIGS. 7 and 8, the chamber 710 may be at least partially hidden from sight prior to bending, folding, etc. the panel 102. In such examples, the chamber 710 may be partially positioned beneath the rigid backings 742, 744 such that the chamber 710 is largely hidden from view as shown in FIG. 7. As such, the rigid backings 742, 744 may protect the chamber 710 prior to dispensing. When the panel 102 is bent, folded, etc., the panel 102 and the backings 742, 744 may move away from the chamber 710 thereby exposing at least a portion of the chamber 710 as shown in FIG. 8.

Additionally, the rigid backings 742, 744 may have a varying thickness, one or more rib structures positioned adjacent to the chamber 710, one or more cutouts, etc. as explained above relative to FIGS. 1-5. For example, the backings 742, 744 may define cutouts (e.g., touchpoints) 746, 748 substantially similar to the cutouts 146, 148 of FIGS. 1-5. However, the cutouts 746, 748 have a different shape than the cutouts 146, 148. For example, the cutouts 746, 748 of FIGS. 7-9 are arc-shaped, and include inclined sides. In other examples, the cutouts 746, 748 may have another suitable shape such as oval (e.g., like the cutouts 146, 148), rectangular, circular, etc. The cutouts 746, 748 may extend completely or partially through the backings 742, 744. The cutouts 746, 748 may function as grips and/or indicate ideal locations for most effectively and efficiently handling the package 700.

Further, the applicator 708 may be substantially coextensive with the panel 102. For example, and similar to the applicator 108 of FIGS. 1-5, the applicator 708 may have substantially the same size, shape, etc. as the panel 102. In such examples, the width of the backing 758 and/or the chamber 710 may be substantially equal to the width of the panel 102. In other examples, the rigid backings 742, 744, the backing 758 and/or the chamber 710 may not extend to one or more edges of the panel 102, and/or may extend beyond one or more edges of the panel 102.

FIG. 10-12 illustrate a break-open single-dose package 1000 similar to the package 700 of FIGS. 7-9, but including an absorber (instead of an auger) for mixing spreadable consumables. For example, the package 1000 includes the panel 102 and the pockets 134a, 134b of FIGS. 7-9, and an applicator 1008 positioned adjacent the frangible regions 104a, 104b in the panel 102.

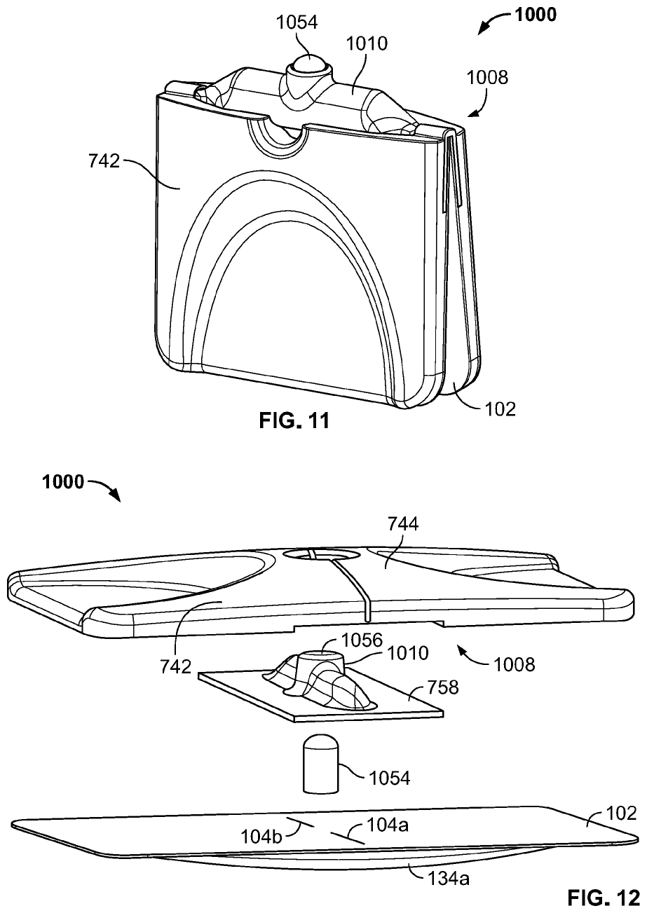

As shown in FIGS. 10-12, the applicator 1008 includes a chamber 1010 defining a reservoir in fluid communication with the frangible regions 104a, 104b, the optional backings 742, 744, 758 of FIGS. 7-9, and an absorber 1054 positioned in the chamber 1010 for mixing together spreadable consumables from the pockets 134a, 134b. For example, the absorber 1054 may be positioned at least partially in an opening 1056 of the applicator 1008 as shown in FIGS. 10 and 11.

During operation, any spreadable consumables that exit the pockets 134a, 134b may flow into the chamber's reservoir and contact the absorber 1054. During this time, the absorber 1054 may become saturated with the spreadable consumables. When the spreadable consumables pass through the absorber 1054, the spreadable consumables may mix due to a turbulent path created in the absorber 1054. The mixed spreadable consumables may then pass through the opening 1056 to permit a user to apply the spreadable consumables onto a surface. In some examples, the user may apply the spreadable consumables with precision by dabbing the absorber 1054 onto the surface.

In the particular example of FIGS. 10-12, the absorber 1054 may be a sponge material. For example, the absorber 1054 may be an open-celled foam or another suitable material. In other examples, the absorber 1054 may be another suitable absorbing material.

The applicator tip openings 140, 756, 1056 of FIGS. 1-12 may have any suitable size. For example, any one of the applicator tip openings may have a small diameter to ensure a precision application of the spreadable consumable(s) on the surface. In some examples, the diameter of the opening may range between about 1 mm and 6 mm. In other examples, the diameter may be less than 1 mm or more than 6 mm. Additionally, the applicator tip opening may be uniform or tapered. For example, the size of the opening adjacent its corresponding reservoir may be smaller or larger than the size of the opening distal the reservoir. In such examples, the opening may function as a well to collect, store, etc. the spreadable consumable before spreading on the surface. Additionally, the tapered opening may assist in controlling the flow rate of the spreadable consumable.

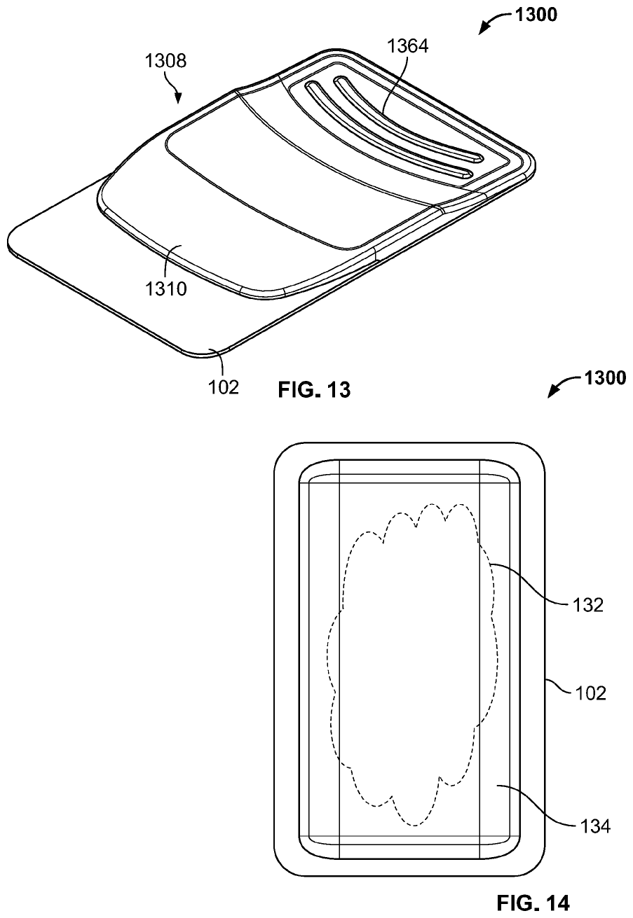

Although the packages 100, 700, 1000 of FIGS. 1-5 and 7-12 are illustrated and described as having two pockets for storing spreadable consumables, it should be apparent that any one of the packages disclosed herein (including the packages 100, 700, 1000) may have a single pocket. For example, FIGS. 13-16 illustrate a break-open single-dose package 1300 including the panel 102 of FIGS. 1-5 defining a frangible region 104, a sheet coupled to the panel 102 and defining a pocket 134 therebetween for storing a spreadable consumable 132, and an applicator 1308 positioned adjacent the frangible region 104. As shown, the applicator 1308 includes an elongated tab 1310 extending in a plane substantially parallel to the panel 102 prior to folding the panel 102. This may reduce the profile of the package 1300 prior to bending, folding, etc. the package 1300 as compared to other single-dose package designs.

The elongated tab 1310 may be used to apply, spread, etc. any spreadable consumable that exits the pocket 134. For example, the elongated tab 1310 extends from an area adjacent the frangible region 104 for permitting a user to spread with the tab 1310 any spreadable consumable that exits the pocket 134 on a surface (e.g., the user's shoulder, etc.) using the applicator 1308 without requiring the user's hand(s) to contact the spreadable consumable 132.

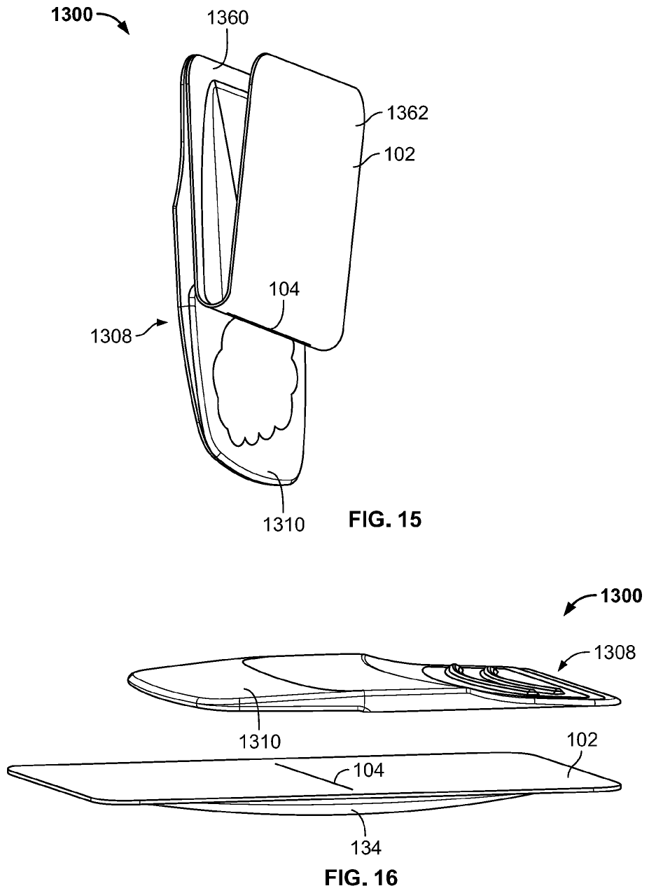

For example, and as shown in FIG. 15, the panel 102 includes two adjacent portions (e.g., halves) 1360, 1362 movable relative to each other. In such examples, the panel 102 may be folded to break (e.g., snap, etc.) the frangible region 104 and force spreadable consumable 132 out of the pocket 134 (as explained herein). In doing so, the panel 102 is folded onto itself while the elongated tab 1310 remains static relative to the panel 102. Thus, and as shown in FIG. 15, the portion 1362 of the panel 102 separates from the elongated tab 1310, while the other portion 1360 remains adjacent to the applicator 1308. This allows any spreadable consumable 132 that has exits the pocket 134 to flow from the opening in the frangible region 104 and along a surface of the elongated tab 1310 as shown in FIG. 15.

In such examples, the elongated tab 1310 may extend from the frangible region 104 a desired distance away from the folded panel 102 which is grasped by the user. As such, the possibility of the spreadable consumable contacting unintended surfaces (e.g., the user's hands) may be reduced as compared to other single-dose package designs.

In the particular example of FIGS. 13-16, the applicator 1308 may be coupled (e.g., adhered, etc.) to the panel 102. For example, the applicator 1308 may be coupled to the portion 1360 of the panel 102, but not to the portion 1362. As such, when the panel 102 may be folded, the portion 1362 separates from the applicator 1308 (e.g., the elongated tab 1310) as explained above.

As shown in FIG. 13, at least a portion of the elongated tab 1310 has a width substantially equal to a width of the panel 102. For example, the elongated tab 1310 includes one end positioned adjacent to the frangible region 104, and another end positioned distal to the frangible region 104. In such examples, the width of the elongated tab 1310 at the end near the frangible region 104 is substantially equal to a width of the panel 102. In other examples, the width at this end may be smaller or larger than the width of the panel 102.

In some examples, the width of the elongated tab 1310 may taper from one end to another end. For example, and as shown in FIG. 13, the width of the elongated tab 1310 tapers from the end near the frangible region 104 to the opposing end distal to the frangible region 104. In other examples, the width of the elongated tab 1310 may remain substantially the same, taper from the end distal to the frangible region 104 to the end near the frangible region 104, etc.

As shown in FIGS. 13-16, the elongated tab 1310 is generally rectangular-shaped with tapering sides. In such examples, the end distal to the frangible region 104 includes a substantially straight edge and rounded corners. In other examples, this end may include another suitable configuration such as a curved edge, a serrated edge, square corners, etc. In some examples, the elongated tab 1310 may have a triangular shape. In such examples, the end distal to the frangible region 104 may form a vertex (e.g., a rounded vertex, etc.).

In the particular example of FIGS. 13-16, the elongated tab 1310 is flexible. For example, when the elongated tab 1310 is used to apply, spread, etc. any spreadable consumable 132 that exits the pocket 134, the elongated tab 1310 may flex thereby allowing at least some portions of the elongated tab 1310 to become substantially flush with a corresponding surface.

In some examples, the applicator 1308 may include one or more grips to facilitate user control of the break-open single-dose package during handling. In the particular example of FIGS. 13-16, the applicator 1308 includes grips 1364 positioned on one side of the applicator 1308. In the example of FIGS. 13-16, the grips 1364 are raised portions (e.g., protrusions). Specifically, the grips 1364 include two elongated arc-shaped raised portions. In other examples, more or less grips, different shaped grips, different types of grips, etc. may be employed if desired.

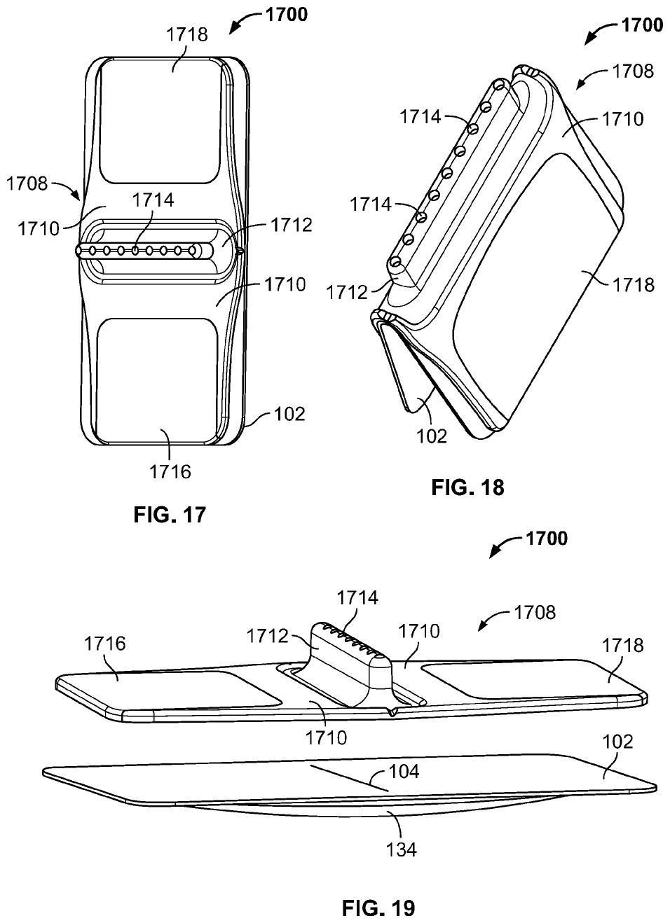

FIGS. 17-19 illustrate a break-open single-dose package 1700 including the panel 102 and the pocket 134 of FIGS. 13-16, and an applicator 1708 positioned adjacent the frangible region 104 of the panel 102 for permitting a user to spread any spreadable consumable that exits the pocket 134 on a surface using the applicator 1708 without requiring the user's hand(s) to contact the spreadable consumable.

As shown in FIGS. 17-19, the applicator 1708 includes a backing 1710 and a blade 1712 for spreading any spreadable consumable that exits the pocket 134. The blade 1712 is positioned adjacent a center portion of the backing 1710. For example, and as shown in FIGS. 17-19, the backing 1710 may define an opening near a center portion of the package 1700, and the blade 1712 may be positioned in the opening. In such examples, the blade 1712 extends away from the backing 1710.

In the particular example of FIGS. 17-19, the blade 1712 may have a substantially rectangular prism shape. Alternatively, the blade 1712 may have another suitable cuboid shape, a triangular prism shape, etc.

As shown in FIGS. 17-19, the blade 1712 defines multiple openings 1714 for conveying the spreadable consumable that exits the pocket 134 to a surface. In the particular example, the blade 1712 includes nine discrete openings (e.g., channels) 1714 aligned in a single linear row and extending through the blade 1712. In other examples, the blade 1712 may include more or less openings. In some examples, the openings may be in multiple rows, a single curved row, etc. For example, the blade 1712 may include one opening, five openings, twelve openings, etc. The openings may be the same size or different depending on, for example, desired exit flow rate of the spreadable consumable, size of the blade, etc.

In the example of FIGS. 17-19, the openings 1714 are in fluid communication with frangible region 104 of the panel 102. For example, an opening in the frangible region 104 (formed after the frangible region 104 is broke) may be adjacent to the openings 1714 in the blade 1712 for allowing the spreadable consumable to pass into and through the blade 1712. In some examples, the blade openings 1714 may assist a user in applying and controlling the spreadable consumable that has entered the blade 1712. For example, one or more of the openings 1714 may be sized to ensure a particular amount of spreadable consumable exits the applicator 1308 over a period of time (e.g., a controlled exit flow rate, a controlled release, etc.). Additionally, the openings 1714 may direct the spreadable consumable exiting the pocket 134 to particular areas on a surface.

In some examples, the blade 1712 may be flexible. For example, the blade 1712 may be formed of a resilient material (e.g., an elastomer material, etc.). As such, when the blade 1712 is pressed against a surface (e.g., the user's shoulder, etc.), the blade 1712 may flex against the surface. This may cause a larger portion of the blade 1712 to contact the surface thereby ensuring the spreadable consumable is uniformly spread and distributed on the surface.

The backing 1710 may be similar to the other backings disclosed herein. For example, the backing 1710 may provide at least some rigidity and uniform pressure on the pocket 134 when the panel 102 is folded. For instance, the backing 1710 is substantially mirrored on opposing sides of the blade 1712, as shown in FIGS. 17-19. This may ensure the backing 1710 applies a substantially uniform pressure on the pocket 134 when the panel 102 is folded, as explained herein.

In the particular example of FIGS. 17-19, the applicator 1708 includes touchpoints (e.g., touchpads) 1716, 1718 for facilitating user control of the package 1700. For example, the touchpoints 1716, 1718 may indicate to users ideal locations for most effectively and efficiently handling the package 1700, assist users in grasping, handling, etc. the package 1700, etc. In some examples, the touchpoints 1716, 1718 may function as grips. In the example of FIGS. 17-19, the touchpoints 1716, 1718 are positioned on opposing sides of the blade 1712. In other examples, the applicator 1708 may include one or more raised portions (e.g., protrusions) on one or both sides of the blade 1712, as explained above relative to FIGS. 13-16.

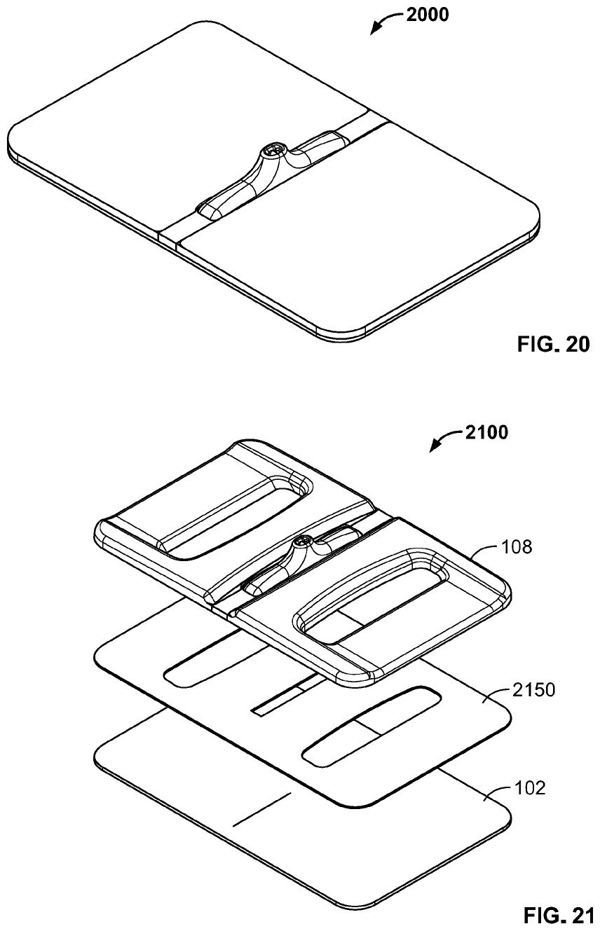

In some examples, any one of the applicators disclosed herein may not include a grip. For example, FIG. 20 illustrates a break-open single-dose package 2000 substantially similar to the package 100 of FIGS. 1-5, but where its applicator includes no grips.

Additionally, any one of the applicators may be coupled to a side of the panel 102 opposing the pocket(s). Specifically, any one of the applicators may be coupled to the panel 102 via adhesive (e.g., tape such as double sided tape, pressure sensitive adhesive, etc.), one or more mechanical devices (e.g., clamps, clips, etc.), etc. In other examples, the applicators may be coupled to the panel 102 by welding (e.g., ultrasonic welding, vibration welding, etc.) the layers together. For example, FIG. 21 illustrates a break-open single-dose package 2100 including the applicator 108 and the panel 102 of FIGS. 1-5, and adhesive 2150 positioned between the applicator 108 and the panel 102 for coupling the applicator 108 and the panel 102. In the particular example of FIG. 21, the adhesive 2150 is an acrylic adhesive tape. In some examples, the acrylic adhesive tape may include cutouts corresponding to the cutouts 146, 148 and the channels 136a, 136b, as shown in FIG. 21.

The applicators disclosed herein may be formed of the same material or different materials, one continuous piece of material (e.g., a monolithic construction), separate components coupled together, etc. For example, the backing(s), the chamber, the tab, the blade, and/or the grips of any one of the applicators may be formed with one continuous piece of material, separate parts of the same material or different materials, etc.

The applicators disclosed herein may be formed of any suitable material. In some examples, the applicators may be formed of flexible materials such as silicone and/or other suitable elastomer materials. In some particular examples, the applicators include a flexible thermoplastic material such as thermoplastic elastomer (TPE). In other examples, the applicators may include another suitable material such as polypropylene (PP), thermoplastic polyurethane (TPU), acrylonitrile butadiene styrene (ABS), etc. In some examples, the material may have a hardness of about 60 shore A to about 80 shore A.

Any one of the applicators disclosed herein permit a user to apply spreadable consumable on a surface using the applicator without requiring the user's hand(s) to contact the spreadable consumable when using the package. For example, the spreadable consumable may be undesirable or harmful to touch, and/or easier to spread with the applicator than by hand. Thus, a user can dispense the spreadable consumable from the pocket and spread the consumable on a surface using the applicator without coming into contact with the spreadable consumable. As such, the user may spread the spreadable consumable on the surface without contacting the spreadable consumable and/or the surface.

The packages disclosed herein are single-dose packages. For example, in some embodiments the packages may not be reused (e.g., refilled, etc.) after their frangible region is broken. In some examples, the single-dose package includes only one pocket holding a single consumable (e.g., any one of the example packages of FIGS. 13-19). In other examples, the package may include two or more pockets (e.g., any one of the example packages of FIGS. 1-12) for holding the same or different materials (including, for example, part A and part B of particular medicant or other consumable).

The panels disclosed herein may provide structural integrity to the package. For example, the panels (e.g., support panels) may be substantially rigid structures that provide a user greater ease when grasping, manipulating, etc. the package.

The panels and/or the pockets disclosed herein may be formed of any suitable material. For example, the panels may include plastic, cardboard, silicone, etc. In some examples, the panels and/or the pockets may be formed of various materials to create multilayer configurations. For instance, any one of the panels disclosed herein may include one or more layers (e.g. sheets) of polyethylene terephthalate (PET), polystyrene (PS), aluminum, polyethylene (PE), etc. In some particular examples, the panels may be formed of a PET layer, a PS layer, an aluminum layer, and a PE layer, in that order. In some examples, the panels are rigid or semi-rigid. The pockets may be defined by a single sheet or multiple sheets such as one or more include flexible sheets. In some examples, the sheets may include one or more layers of PET, aluminum, PE, etc. In some particular examples, the sheets defining the pockets may be formed of a PET layer, an aluminum layer, another PET layer and a PE layer, in that order.

The frangible regions disclosed herein form an opening through which the spreadable consumable can exit in response to folding of the panel. For example, and as explained herein, the opening may be formed when the panel is folded, bent, etc. along an axis and away from the applicator. This movement allows portions of the panel to move closer together causing the sealed pocket to fold onto itself thereby applying pressure to the pocket and, in particular, to the frangible region. Because of this pressure, the frangible region may break (e.g., snap, etc.) to form the opening for dispensing the spreadable consumable. In some examples, the frangible region may break when the panel is folded such that the panel's portions are about 90 degrees apart, more or less than 90 degrees apart, etc.

Additionally, the panels may be used to force the spreadable consumables out of the pockets. For example, after the frangible region is broken, a user may fold, bend, etc. (e.g. continue to fold, bend, etc.) the panel with one or both of the user's hand. As a result, a force (e.g., pressure) may be applied to the pocket causing the spreadable consumable to exit the frangible region's opening. In some examples, the force applied to the pocket may be controlled by a user. As such, movement of the panel may form the frangible region's opening and force the spreadable consumable out of the pocket via the opening.

The frangible regions disclosed herein may be formed in various different manners. For example, any one of the frangible regions may be formed by cutting a portion of the panel to form one or more scored lines on one or both sides of the panel, folding the package, deforming the package, etc. In some examples, the panel may be formed of one or more layers of material as explained herein. In such cases, the frangible region may be formed of less layers, a thinner layer, weaker material(s), etc. than other portions of the panel to create the frangible region. In some examples, any one of the panels may include only one frangible region. In other example examples, the panel may include more than one frangible region.

In some examples, the frangible region may be designed to fail before other portions of the package (e.g., the pocket) fail so that the spreadable consumable stored in the pocket can exit the pocket only through the frangible region's opening. For example, the frangible region may be designed to fail (e.g., break, etc.) in response to a force less than the force required to break other portions of the pocket. This can be accomplished by material selection, the manner in which the frangible region is formed, etc.

The spreadable consumable disclosed herein may include various different liquids, creams, ointments, gels, pastes, and/or other suitable spreadable consumable commonly applied to a person's skin. For example, the spreadable consumable may include medicated or non-mediated materials, prescription or non-prescription material(s), etc. In some examples, the spreadable consumable may include an active pharmaceutical ingredient (API). Additionally, the spreadable consumable may have a viscosity ranging between, for example, 2,000 cps and 15,000 cps. In other examples, the spreadable consumable may have a viscosity ranging between, for example, 25,000 cps and 35,000 cps. In some preferred embodiments, the spreadable consumable contained in the pockets (and dispersed) may include testosterone gels, acne medications, sanitizers, cosmetics, lubricants, etc.

In other embodiments, the surface may be part of a food related product, a brick, a piece of wood, a piece of plastic, etc. In such cases, the spreadable consumable may include condiments (e.g., ketchup, barbeque sauce, etc.), caulk, adhesives, and/or other suitable spreadable consumable.

The surfaces disclosed herein may include surfaces of various different objects. For example, a surface may be a person's skin. In such examples, a user can use one of the applicators to spread the spreadable consumable by rubbing the applicator across his/her skin and/or another person's skin without cutting, aggravating, etc. the skin. As such, the packages may be used to apply the spreadable consumable to otherwise sensitive areas. The spreadable consumable may be applied over a large surface area such as the user's shoulder, arm, etc. and/or applied at precise location (e.g., a pimple, a sore, etc.)

The sealable pockets disclosed herein may have any suitable volume. For example, the sealable pockets may have a volume to store between about 0.25 mL and about 1 mL of spreadable consumable. In other examples, the volume may be larger or smaller to store more or less spreadable consumable.

Additionally, the packages disclosed herein (e.g., the packages 100, 700, 1000 of FIGS. 1-12) may include dual pockets. In such examples, the dual pockets may be shaped and/or orientated in any suitable manner to allow the spreadable consumables to exit the pockets. For example, the pockets may have a substantially rectangular shape, and extend along the length of the panel, as shown in FIG. 3. Alternatively, the pockets may have a substantially square shape, and be positioned on opposing sides of the panel's foldable axis.

The packages disclosed herein may be sized as desired. For example, any one of the packages may range in size from 40 mm×50 mm to 80 mm×100 mm. In some particular examples, any one of the packages may have an exterior dimension of 43 mm×70 mm, and an interior dimension (e.g., defining its pocket) of 33 mm×60 mm.

In some examples, the packages may be defined by layers of material(s). For example, any one of the packages may include a panel layer defining the panel 102, a pocket layer coupled to the panel layer and defining one or more sealable pockets therebetween, and an applicator layer coupled to the panel layer and defining an applicator (e.g., the applicator 108). In some examples, the packages may be manufactured by coupling the panel layer to the pocket to form the sealable pocket. These layers may form a pack such as an EASYSNAP pack. Additionally, the applicator layer may be coupled to the panel layer on a side opposing of the sealable pocket. It should be understood, however, that references to “layers” herein are not intended to require a particular construction methodology or order.

Although the break-open single-dose packages disclosed herein are shown and/or described as having specific features, it should be apparent that any one or more of the features may be optional. Therefore, any one of the packages disclosed herein and/or another suitable package may include one or more of the optional features without departing from the scope of the disclosure.

Also disclosed are the following numbered clauses:

1. A break-open single-dose package, comprising:

a panel defining one or more frangible regions;

one or more sheets coupled to the panel and defining at least two pockets therebetween for storing a spreadable consumable, the one or more frangible regions adapted to form an opening through which the spreadable consumable can exit in response to folding of the panel; and

an applicator positioned adjacent the one or more frangible regions for permitting a user to spread on a surface any spreadable consumable that exits the at least two pockets using the applicator without requiring the user's hand(s) to contact the spreadable consumable, the applicator including a chamber defining a reservoir in fluid communication with the one or more frangible regions for receiving the spreadable consumable from the at least two pockets in response to folding of the panel, and an auger positioned in the chamber for mixing together the spreadable consumable from said each of the pockets.

2. The break-open single-dose package of any preceding claim, wherein the applicator includes at least two rigid backings positioned on opposing sides of the chamber for applying a substantially uniform pressure to said each pocket in response to folding of the panel.

3. The break-open single-dose package of any preceding claim, wherein the applicator is substantially coextensive with the panel

4. The break-open single-dose package of any preceding claim, wherein, in response to folding of the panel, the at least two rigid backings is configured to move with the panel and separate from the chamber.

5. The break-open single-dose package of any preceding claim, wherein at least one of the rigid backings defines a cutout configured to indicate desired placement of the user's finger/thumb during handling of the break-open single-dose package.

6. The break-open single-dose package of any preceding claim, wherein at least one of the rigid backings has a varying thickness.

7. The break-open single-dose package of any preceding claim, wherein at least one of the rigid backings includes one or more ribs positioned adjacent to the chamber.

8. The break-open single-dose package of any preceding claim, wherein the chamber defines an opening in fluid communication with the reservoir for permitting the mixed spreadable consumable from the at least two pockets to exit the applicator.

9. The break-open single-dose package of any preceding claim, wherein the auger has a helical shape.

10. The break-open single-dose package of any preceding claim, wherein the applicator includes one or more grips to facilitate user control of the break-open single-dose package during handling.

11. The break-open single-dose package of any preceding claim, further comprising a spreadable consumable stored in at least one of the pockets.

12. A break-open single-dose package, comprising:

a panel defining one or more frangible regions;

one or more sheets coupled to the panel and defining at least two pockets therebetween for storing a spreadable consumable, the one or more frangible regions adapted to form an opening through which the spreadable consumable can exit in response to folding of the panel; and

an applicator positioned adjacent the one or more frangible regions for permitting a user to spread on a surface any spreadable consumable that exits the at least two pockets using the applicator without requiring the user's hand(s) to contact the spreadable consumable, the applicator including a chamber defining a reservoir in fluid communication with the one or more frangible regions for receiving the spreadable consumable from the at least two pockets in response to folding of the panel, and an absorber positioned in the chamber for mixing together the spreadable consumable from said each of the pockets.

13. The break-open single-dose package of any preceding claim, wherein the applicator includes at least two rigid backings positioned on opposing sides of the chamber for applying a substantially uniform pressure to said each pocket in response to folding of the panel.

14. The break-open single-dose package of any preceding claim, wherein the applicator is substantially coextensive with the panel

15. The break-open single-dose package of any preceding claim, wherein, in response to folding of the panel, the at least two rigid backings is configured to move with the panel and separate from the chamber.

16. The break-open single-dose package of any preceding claim, wherein at least one of the rigid backings defines a cutout configured to indicate desired placement of the user's finger/thumb during handling of the break-open single-dose package.

17. The break-open single-dose package of any preceding claim, wherein at least one of the rigid backings has a varying thickness.

18. The break-open single-dose package of any preceding claim, wherein at least one of the rigid backings includes one or more ribs positioned adjacent to the chamber.

19. The break-open single-dose package of any preceding claim, wherein the chamber defines an opening in fluid communication with the reservoir for permitting the mixed spreadable consumable from the at least two pockets to exit the applicator.

20. The break-open single-dose package of any preceding claim, wherein the absorber is positioned at least partially in the opening, and wherein the absorber is adapted to spread the mixed spreadable consumable on the surface.

21. The break-open single-dose package of any preceding claim, wherein the absorber includes a sponge.

22. The break-open single-dose package of any preceding claim, wherein the applicator includes one or more grips to facilitate user control of the break-open single-dose package during handling.

23. The break-open single-dose package of any preceding claim, further comprising a spreadable consumable stored in at least one of the pockets.

24. A break-open single-dose package, comprising:

a panel defining a frangible region;

one or more sheets coupled to the panel and defining a pocket therebetween for storing a spreadable consumable, the frangible region adapted to form an opening through which the spreadable consumable can exit in response to folding of the panel; and

an applicator positioned adjacent the frangible region, the applicator including an elongated tab extending in a plane substantially parallel to the panel prior to folding of the panel, at least a portion of the elongated tab having a width substantially equal to a width of the panel, and the elongated tab extending in the plane from an area adjacent the frangible region for permitting a user to spread with the tab any spreadable consumable that exits the pocket on the surface using the applicator without requiring the user's hand(s) to contact the spreadable consumable.

25. The break-open single-dose package of any preceding claim, wherein the elongated tab is flexible.

26. The break-open single-dose package of any preceding claim, wherein the elongated tab includes a first end positioned adjacent to the frangible region and a second opposing end positioned distal to the frangible region, and wherein a width of the elongated tab tapers from the first end to the second end.

27. The break-open single-dose package of any preceding claim, wherein the panel includes a first portion and a second portion adjacent the first portion, wherein the applicator is coupled to the first portion of the panel, and wherein, in response to folding of the panel, the second portion of the panel is configured to separate from the elongated tab.

28. The break-open single-dose package of any preceding claim, wherein the applicator is not coupled to the second portion of the panel.

29. The break-open single-dose package of any preceding claim, wherein the applicator includes one or more grips to facilitate user control of the break-open single-dose package during handling.

30. The break-open single-dose package of any preceding claim, further comprising a spreadable consumable stored in the pocket.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A break-open single-dose package, comprising:
a panel defining one or more frangible regions;
one or more sheets coupled to the panel and defining at least two pockets therebetween for storing spreadable consumables, the one or more frangible regions adapted to form an opening through which the spreadable consumables can exit in response to folding of the panel; and
an applicator positioned adjacent the one or more frangible regions for permitting a user to spread on a surface any spreadable consumables that exit the at least two pockets using the applicator without requiring the user's hand(s) to contact the spreadable consumables, the applicator including a chamber having a perimeter wall and a divider wall, the perimeter wall and the divider wall defining at least two channels in fluid communication with the one or more frangible regions for receiving the spreadable consumables from the at least two pockets in response to folding of the panel, and the divider wall separating the at least two channels to prevent the spreadable consumables from the at least two pockets from mixing when passing through the at least two channels.

2. The break-open single-dose package of claim 1, wherein the applicator includes at least two rigid backings positioned on opposing sides of the chamber for applying a substantially uniform pressure to the at least two pockets in response to folding of the panel.

3. The break-open single-dose package of claim 2, wherein the applicator is substantially coextensive with the panel.

4. The break-open single-dose package of claim 2, wherein, in response to folding of the panel, the at least two rigid backings is configured to move with the panel and separate from the chamber.

5. The break-open single-dose package of claim 2, wherein at least one of the rigid backings defines a cutout to indicate desired placement of the user's finger/thumb during handling of the break-open single-dose package.

6. The break-open single-dose package of claim 2, wherein at least one of the rigid backings has a varying thickness.

7. The break-open single-dose package of claim 2, wherein at least one of the rigid backings includes one or more ribs positioned adjacent to the chamber.

8. The break-open single-dose package of claim 1, wherein the chamber has a width substantially equal to a width of the panel.

9. The break-open single-dose package of claim 1, wherein the chamber defines an opening in fluid communication with the at least two channels for permitting the spreadable consumable from the at least two pockets to exit the applicator.

10. The break-open single-dose package of claim 9, wherein the divider wall extends between the panel and the opening.

11. The break-open single-dose package of claim 1, wherein the applicator includes one or more grips to facilitate user control of the break-open single-dose package during handling.

12. The break-open single-dose package of claim 1, wherein the applicator includes acrylonitrile butadiene styrene and a thermoplastic elastomer.

13. The break-open single-dose package of claim 1, further comprising a spreadable consumable stored in at least one of the pockets.
